(19) United States
(12) Patent Application Publication
(10) Pub. No.: US 2007/0134054 A1
(43) Pub. Date: Jun. 14, 2007

(54) RING BINDER MECHANISM

(76) Inventor: Shan Jun Li, Chongqing city (CN)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/566,955

(22) Filed: Dec. 5, 2006

(30) Foreign Application Priority Data
Dec. 8, 2005 (CN) 200510129443.1

(51) Int. Cl. B42F 13/20

(52) U.S. Cl. 402/36

(57) ABSTRACT

The present invention provides a ring binder mechanism comprising a housing having a top portion and an open bottom generally opposed to the top portion; hinge plates supported by the housing for pivoting motion relative to the housing; rings for holding loose-leaf pages, each ring including a first ring member and a second ring member, the first ring member being mounted on a first hinge plate and moveable with the pivoting motion of the first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings; and a travel bar disposed between the top portion of the housing and the hinge plates and having a plurality of projections, at least one of the projections having a structure to block the hinge plates from pivoting upward relative to the housing and at least other one of the projections having a structure to allow the hinge plates to pivot upward relative to the housing. The ring binder mechanism according to the present invention may be opened by pulling only a pair of particular ring members and closed by pushing any pair of ring members, thereby reducing the risk of paper's falling out thanks to unintentional opening of the mechanism.

### FIELD OF THE INVENTION

This invention relates generally to a ring binder mechanism for retaining loose-leaf pages, and in particular to an improved mechanism for opening and closing ring members and for locking closed ring members together.

### BACKGROUND OF THE INVENTION

Conventionally, a ring binder mechanism typically retains loose-leaf pages, such as hole-punched papers, in a file or notebook. The ring binder mechanism comprises generally a plurality of rings each consisting of two ring members which may be selectively opened to add or remove papers, or closed to retain papers while allowing them to be moved along the ring members. The ring members are attached to two adjacent hinge plates. The two hinge plates are supported loosely within an elongate housing in joined relation for pivoting motion relative to the housing. The housing is generally narrower than the joined hinge plates when they are in a coplanar position (180°). So as the hinge plates pivot through the coplanar position, they deform the housing and cause a spring force that urges them to pivot either upward or downward away from the coplanar position. Ring members mounted on the hinge plates move with the pivoting movement of the hinge plates to open or close. When the ring members close, the spring force blocks the movement of the hinge plates and retains the ring members together. Similarly, when the ring members open, the spring force retains them apart. The user may pull or push manually the ring members to overcome the spring force, thereby open or close the ring members. Furthermore, the user may open or close the ring members by operating a lever disposed at one end or two ends of some ring binder mechanisms to move the hinge plates through the coplanar position.

One drawback to the conventional ring binder mechanism is that when the ring members close, the ring binder mechanism may open by pulling the closed ring members of any one ring to pivot the hinge plates through the coplanar position. Such the ring binder mechanism may open easily and unintentionally under an external force, especially when it falls onto the ground or other surfaces, thereby causing the papers to fall out. Accordingly, it would be desirable to provide an improved ring binder mechanism.

### SUMMARY OF THE INVENTION

One object of the invention is to provide a ring binder mechanism which may be opened by pulling only a pair of particular ring members and closed by pushing any pair of ring members, thereby reducing the risk of paper's falling out thanks to unintentional opening of the mechanism.

Accordingly, the present invention provides a ring binder mechanism comprising:

a housing having a top portion and an open bottom generally opposed to the top portion;

hinge plates supported by the housing for pivoting motion relative to the housing;

rings for holding loose-leaf pages, each ring including a first ring member and a second ring member, the first ring member being mounted on a first hinge plate and moveable with the pivoting motion of the first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings; and

a travel bar disposed between the top portion of the housing and the hinge plates and having a plurality of projections, at least one of the projections having a structure to block the hinge plates from pivoting upward relative to the housing and at least other one of the projections having a structure to allow the hinge plates to pivot upward relative to the housing.

Additional features and advantages of the inventions will become apparent to those skilled in the art upon consideration of the attached drawings in conjunction with the following description of the drawings, which exemplifies the best mode of carrying out the invention as presently perceived, or can be learned through practice of the invention.

### BRIEF DESCRIPTION OF THE DRAWINGS

FIG. 1 is a side view of a ring binder mechanism of a first embodiment of the present invention;

FIG. 2 is a top view of the ring binder mechanism of FIG. 1;

FIG. 3 is a bottom view of the ring binder mechanism of FIG. 1;

FIG. 4 is an end view of the ring binder mechanism of FIG. 1;

FIG. 5 is an exploded perspective view of the ring binder mechanism of FIG. 1;

FIG. 6 is a top perspective view of the ring binder mechanism of FIG. 1 with the ring members in the closed and locked position;

FIG. 7 is a bottom perspective view of the ring binder mechanism of FIG. 1 with the ring members in the closed and locked position;

FIG. 8 is a side view of the ring binder mechanism of FIG. 1 with the ring members in the closed and locked position and with the housing removed to show internal construction, in which the detail structure is also shown with two partially enlarged views;

FIG. 9 is a top perspective view of the ring binder mechanism of FIG. 1 with a pair of particular ring members just opened and other ring members closed;

FIG. 10 is a bottom perspective view of the ring binder mechanism of FIG. 1 with a pair of particular ring members just opened and other ring members closed;

FIG. 11 is a view similar to FIG. 8, showing internal state of the ring binder mechanism of FIGS. 9 and 10;

FIG. 12 is a top perspective view of the ring binder mechanism of FIG. 1 with the ring members in the opened position;

FIG. 13 is a bottom perspective view of the ring binder mechanism of FIG. 1 with the ring members in the opened position;

FIG. 14 is a view similar to FIG. 8, showing internal state of the ring binder mechanism of FIGS. 12 and 13;

FIG. 15 is an exploded perspective view of a ring binder mechanism of a second embodiment of the present invention;

FIG. 16 is a top perspective view of the ring binder mechanism of FIG. 15 with the ring members in the closed and locked position;

FIG. 17 is a side view of a ring binder mechanism of a third embodiment of the present invention;

FIG. 18 is a top view of the ring binder mechanism of FIG. 17;

FIG. 19 is a bottom view of the ring binder mechanism of FIG. 17;

FIG. 20 is an end view of the ring binder mechanism of FIG. 17;

FIG. 21 is an exploded perspective view of the ring binder mechanism of FIG. 17;

FIG. 22 is a top perspective view of the ring binder mechanism of FIG. 17 with the ring members in the closed and locked position;

FIG. 23 is a bottom perspective view of the ring binder mechanism of FIG. 17 with the ring members in the closed and locked position;

FIG. 24 is a bottom perspective view of the ring binder mechanism of FIG. 17 with the ring members in the closed and locked position and with part of a housing broken away and some ring members and a hinge plate removed to show internal construction;

FIG. 25 is a side view of the ring binder mechanism of FIG. 17 with the ring members in the closed and locked position and with the housing removed to show internal construction, in which the detail structure is also shown with two partially enlarged views;

FIG. 26 is a top perspective view of the ring binder mechanism of FIG. 17 with a pair of particular ring members just opened and other ring members closed;

FIG. 27 is a bottom perspective view of the ring binder mechanism of FIG. 17 with a pair of particular ring members just opened and other ring members closed;

FIG. 28 is a view similar to FIG. 25, showing internal state of the ring binder mechanism of FIGS. 26 and 27;

FIG. 29 is a top perspective view of the ring binder mechanism of FIG. 17 with the ring members in the opened position;

FIG. 30 is a bottom perspective view of the ring binder mechanism of FIG. 17 with the ring members in the opened position;

FIG. 31 is a view similar to FIG. 25, showing internal state of the ring binder mechanism of FIGS. 26 and 27;

FIG. 32 is an exploded perspective view of a ring binder mechanism of a fourth embodiment of the present invention; and

FIG. 33 is a top perspective view of the ring binder mechanism of FIG. 32 with the ring members in the closed and locked position;

Corresponding reference numerals indicate corresponding parts throughout the views of the drawings.

### DETAILED DESCRIPTION OF THE PREFERRED EMBODIMENTS

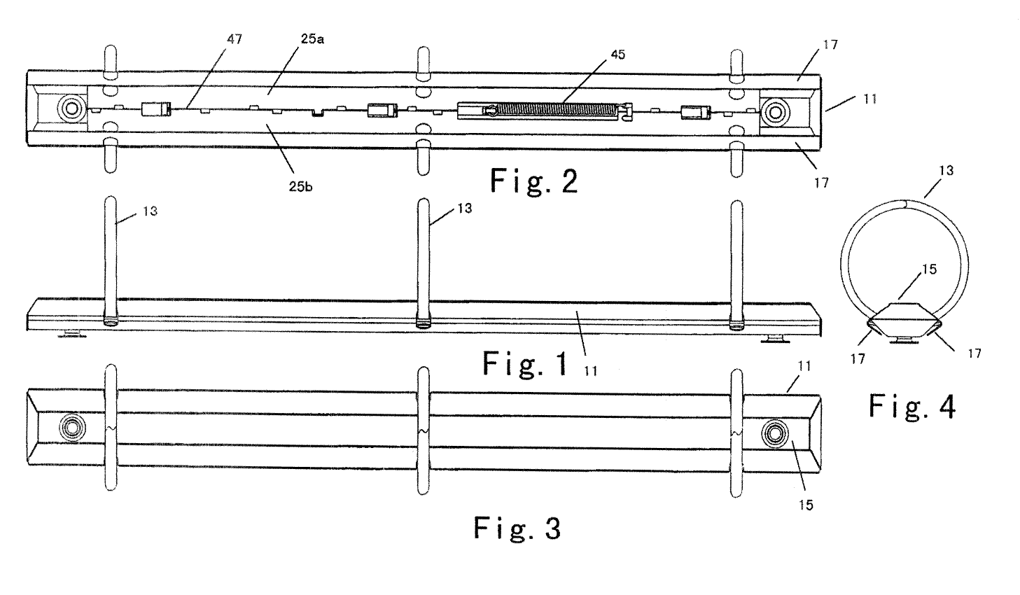

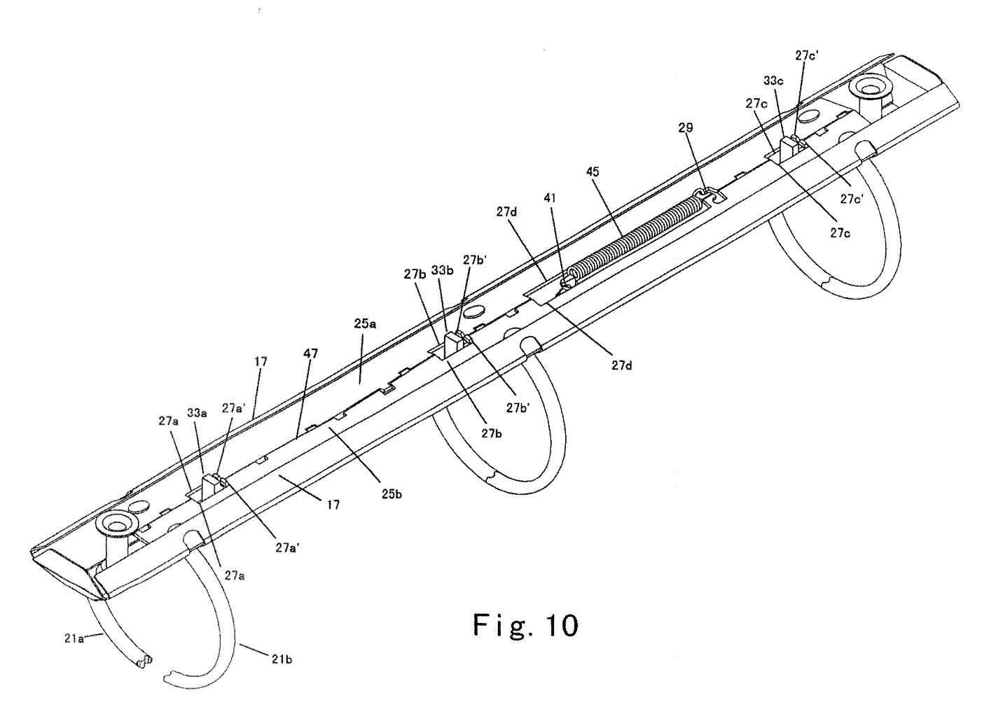

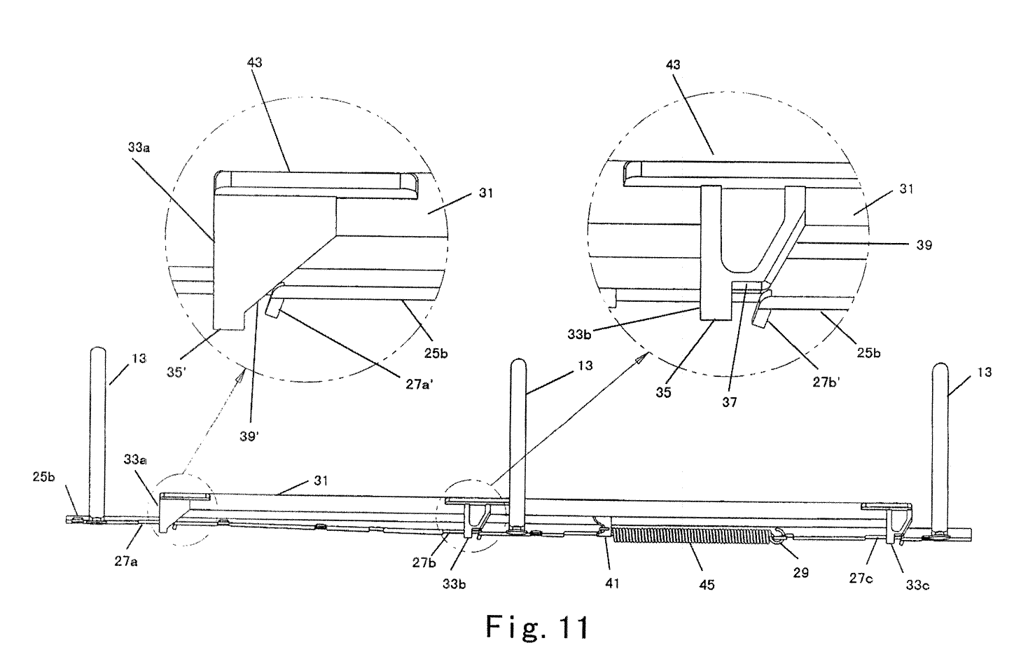

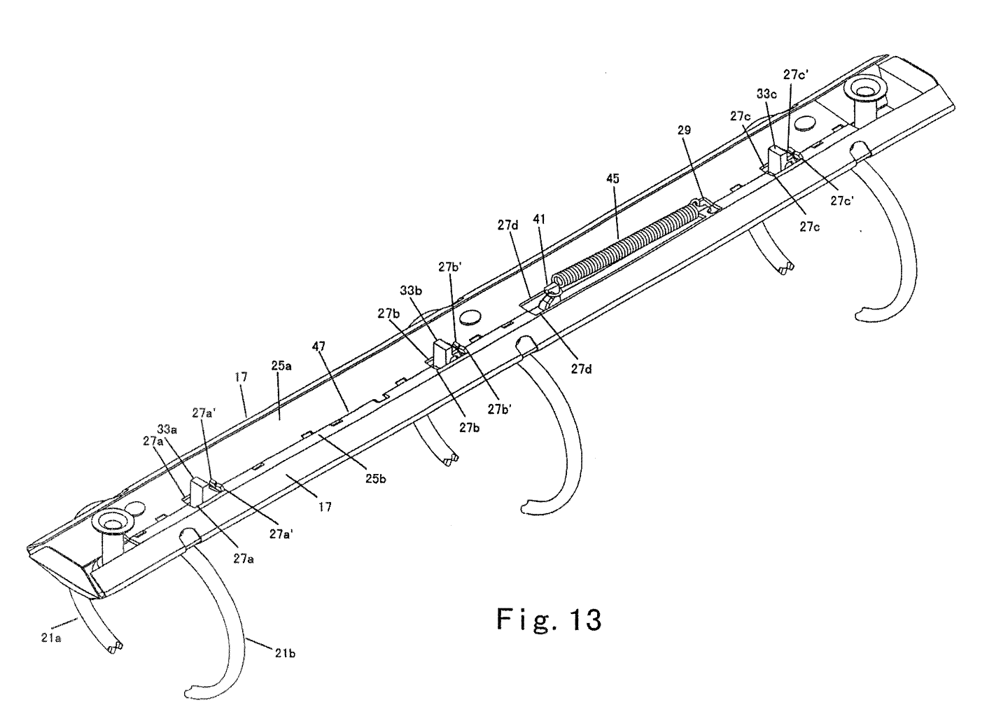

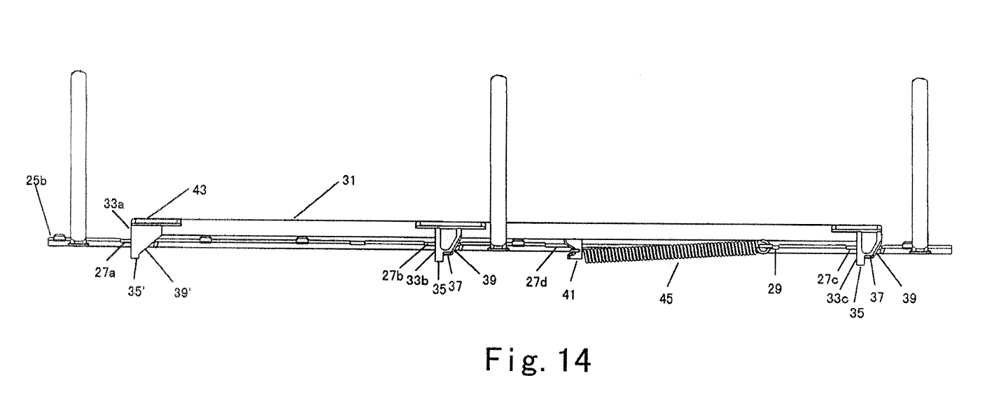

Referring now to the drawings, FIGS. 1-14 show a ring binder mechanism 1 according to a first embodiment of the invention. The ring binder mechanism 1 generally includes a housing indicated generally at 11 and three rings 13 supported by the housing 11. The rings 13 retain loose-leaf pages on the ring binder mechanism 1. By operating the particular ring 13 as described later, the ring binder mechanism 1 may be opened and closed to add or remove pages. Referring to FIG. 2, the housing 11 is elongate with a uniform, generally trapezoid cross section having at its center a raised plateau 15. The two longitudinal ends of the housing 11 are generally closed. Bent under rims 17 extend from one longitudinal end of the housing to the other along two longitudinal edges of the housing 11 respectively. It is understood that a ring mechanism with a housing of other shapes (for example, a housing with an arc-shaped cross section) including irregular shapes does not depart from the scope of the invention.

Three rings 13 of the ring binder mechanism 1 are substantially identical and have roughly circular profile. As shown in the drawings, the rings 13 each include two roughly semi-circular ring members 21a, 21b formed from a conventional, cylindrical rod of a suitable material such as steel. The ring members 2la, 21b have respective fee ends 23a, 23b. The free ends 23a, 23b are formed so that they may securely hold the ring members together against misalignment (relative to the longitudinal axis of the ring members) when in the closed position of the rings. The D-shaped rings known in the art also fall within the scope of the invention. Furthermore, the ring members having different cross-sections (for example, elliptical cross-section) or formed from different materials do not depart from the scope of the invention.

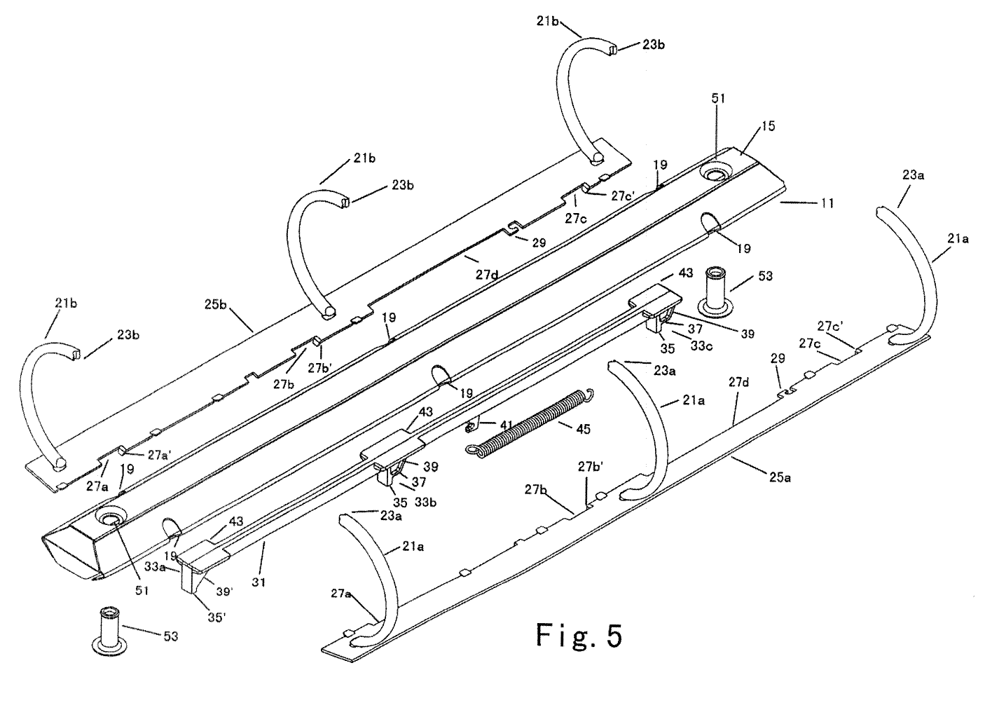

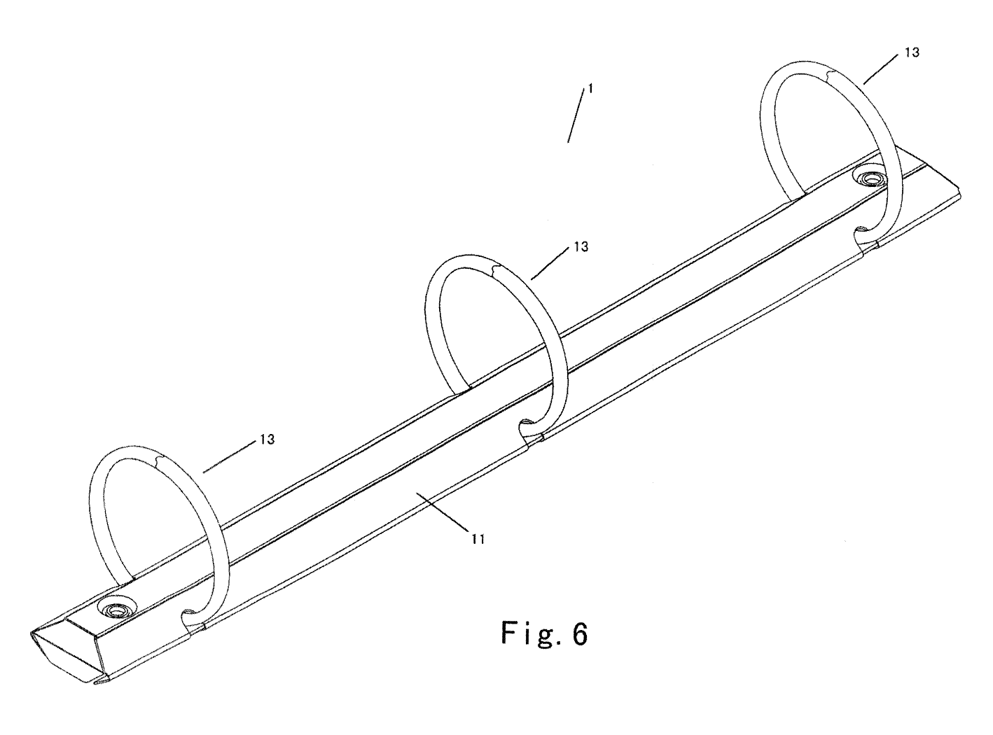

As shown in FIG. 5, the ring binder mechanism 1 includes two mirror image hinge plates 25a, 25b each supporting respective ring members 21a, 21b. Each of the hinge plates 25a, 25b is thin and rectangular in shape. The hinge plates 25a, 25b are slightly shorter than the 25a, 25b along the inner edge of the hinge plates 25a, 25b. The cutouts 27d are longer than other three cutouts 27a-27c in the longitudinal direction of the hinge plates 25a, 25b. The hooked portions 29 are formed on the inner edge of the hinge plates 25a, 25b adjacent the cutouts 27d. The use of the cutouts 27a-27d and the hooked portions will be described later.

As shown in FIG. 5, the ring binder mechanism 1 also includes an elongate and substantially flat and rectangular travel bar 31, which is oriented in a substantially vertical plane as shown by the drawings to lock the ring members 21a, 21b together while they close. The travel bar 31 includes three inverted L-shaped projections 33a33c extending integrally and downward from the travel bar 31 within the plane of the travel bar. The projections 33a-33c are spaced from each other along the longitudinal direction of the travel bar 31 so that two projections 33a, 33c thereof are adjacent to each longitudinal end of the travel bar 31 respectively and other projection 33b is slightly offset from the center of the travel bar 31. It is understood that a travel bar having different shapes and more or less than three projections does not depart from the scope of the invention.

The projections 33b, 33c have the same shape and include a suspending portion 35 extending downward from the bottom surface of the travel bar 31, a shoulder portion 37 extending perpendicularly to the suspending portion 35 and a sloping portion 39 extending upward and slopingly from the shoulder portion 37 toward the bottom surface of the travel bar 31. The projection 33a is slightly different from the projections 33b, 33c in shape. Specifically, the projection 33a includes a suspending portion 35′ extending downward from the bottom surface of the travel bar 31 and a sloping portion 39′ extending upward and slopingly from the suspending portion 35′ toward the bottom surface of the travel bar 31. The travel bar 31 and the integral projections may be formed in a single step.

A hooked portion 41 projecting downward is disposed between the projections 33b, 33c having a relatively large space. Preferably, a plurality of corresponding horizontal extensions 43 are formed on the top surfaces of the travel bar 31. The width of the horizontal extensions 43 is slightly narrower than that of the raised plateau 15 of the housing 11 so that the travel bar 31 may move smoothly along the raised plateau 15 of the housing 11 without changing the moving direction laterally of the housing 11.

Referring to FIGS. 6-8, the assembled ring binder mechanism 1 is described now, wherein the ring members 21a, 21b are shown to be in closed and locked position. As shown in the drawings, the travel bar 31 is disposed within the housing 11 below the raised plateau 15 of the housing 11. The travel bar 31 extends longitudinally along the housing 11 and orients substantially parallel to the longitudinal axis of the housing so that the projections 33a-33c face away from the housing 11.

As shown in FIGS. 5 and 6, the hinge plates 25a, 25b join together in parallel arrangement under the travel bar to form a central pivoting hinge 47 having a pivotal axis. This is achieved in a known way in the art. As described later, the hinge plates 25a, 25b may pivot upward or downward on the central hinge 47. Respective four cutouts 27a-27d in each of the hinge plates 25a, 25b align with each other to form four openings in the interconnected hinge plates. The interconnected hinge plates 25a, 25b are supported in the housing 11 under the travel bar 31 The outer longitudinal edges of the hinge plates 25a, 25b are supported loosely by the bent under rims 17 to be moveable within the bent under rims when the hinge plates pivot.

The ring members 21a, 21b extend through the respective openings 19 formed along the opposite longitudinal sides of the housing 11 to be mounted respectively on the upper surface of the respective hinge plates 25a, 25b with the free ends 23a, 23b facing toward each other. The ring members 21a, 21b are mounted rigidly to the hinge plates 25a, 25b in a known way and move with them when the hinge plates 25a, 25b pivot. Although in the illustrated mechanism 1 in which the ring members 21a, 21b of each ring 13 are mounted respectively to the hinge plate 25a, 25b and move with them, a ring binder mechanism with only one ring member of each ring movable and the other one fixed (for example, a ring binder mechanism with only one ring member of each ring mounted on a hinge plate and the other ring member mounted for example on the housing) does not depart from the scope of the invention.

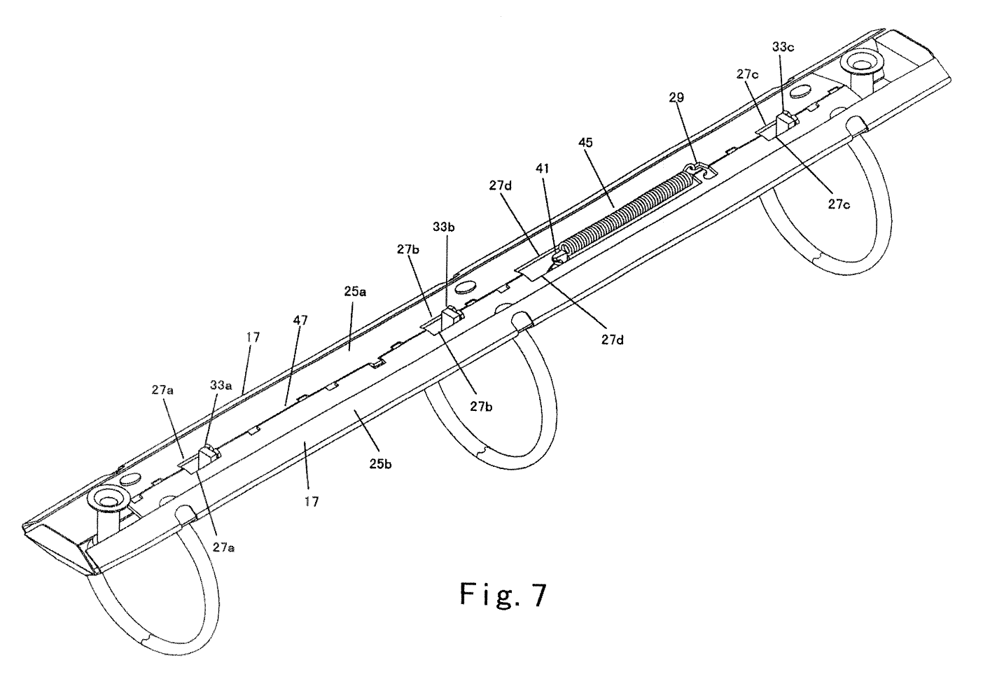

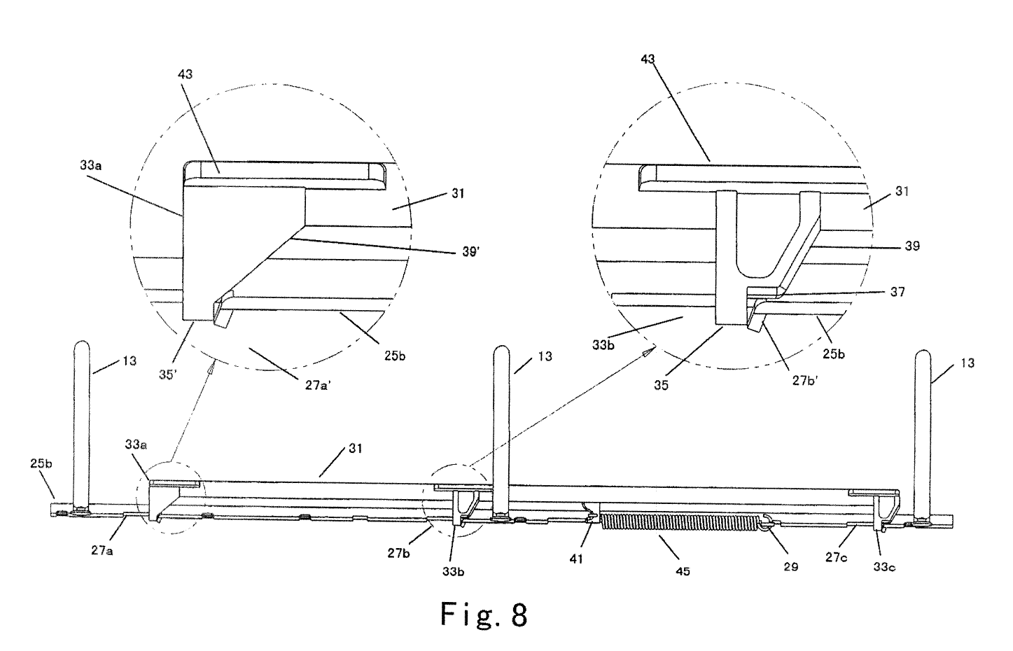

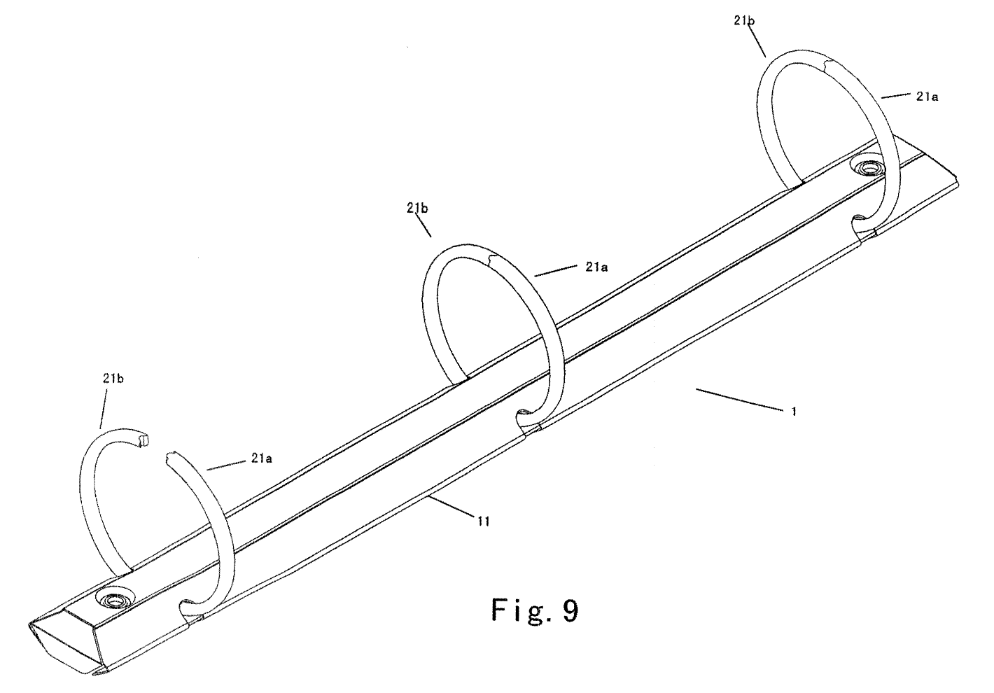

As shown in FIGS. 7 and 8, the travel bar 31 disposed between the raised plateau 15 of the housing 11 and the hinge plates 25a, 25b connects with the hinge plates through a spring 45 so that three projections 33a-33c on the travel bar 31 align respectively with the openings formed by three cutouts 27a-27c on the respective hinge plates 25a, 25b with the spring 45 substantially located in the opening formed by the cutouts 27d on the respective hinge plates 25a, 25b. One end of the spring 45 connects to the hooked portion 29 on the hinge plate and the other end to the hooked portion 41 formed on the travel bar 31 so that the spring 45 is in a tensioned state. Thus, the spring 45 has a potential energy to pull the travel bar 31 toward the right side of FIGS. 7 and 8. Preferably, correspondingly with the sloping portion of each projection, a sloping protrusion 27a′-27c′ is formed at one side of three cutouts 27a-27c facing toward each sloping portion to guide the sloping portion of each projection to slide along it, thereby facilitating the operation of the ring binder mechanism 1.

If necessary, a through hole 51 may be provided at the housing 11 adjacent to one or two of its ends. A fixture 53 such as a rivet may extend through the through hole 51 to secure the ring binder mechanism 1 to the cover of a file or a notebook.

Referring to FIGS. 6-15, the operation of the ring binder mechanism 1 will be described. As known, the hinge plates 25a, 25b may pivot upward or downward relative to the housing 11 and move the ring members 21a, 21b mounted thereto between a closed position and an open position. The hinge plates 25a, 25b are slightly wider than the housing when they are in a coplanar position (180°). So as the hinge plates pivot through the coplanar position, they deform the housing and cause a spring force that urges the hinge plates 25a, 25b to pivot either upward or downward away from the coplanar position. When the hinge plates 25a, 25b pivot downward (i.e. the hinge 47 moves away from the housing 11), the ring members 21a, 21b close; when the hinge plates 25a, 25b pivot upward (i.e. the hinge 47 moves toward the housing 11), the ring members 21a, 21b open.

In FIGS. 6-8, the ring binder mechanism 1 is shown to be in closed and locked position. The hinge plates 25a, 25b are hinged downward away from the raised plateau of the housing so that the ring members 21a, 21b of each ring 13 close together to form a continuous loop for retaining loose-leaf pages. As shown in FIG. 8, at that time, the projections 33a-33c on the travel bar 31 align with the hinge 47 above the hinge plates 25a, 25b so that all of the suspending portions 35, 35′ of the projections 33a-33c are positioned in the openings formed by three cutouts 27a-27c on the respective hinge plates 25a, 25b while the shoulder portions 37 of the projections 33b, 33c engage with the upper surfaces of the hinge plates 25a, 25b and the sloping portion 39′ of the projection 33a abuts against the edge of the opening formed by the cutouts 27aon the respective hinge plates 25a, 25b. If an operator attempts to pull the rings 13 adjacent to the projections 33b, 33c apart, the projections 33b, 33c on the travel bar 31 between the hinge plates 25a, 25b and the raised plateau 15 of the housing block the hinge plates 25a, 25b from pivoting upward, thereby being incapable of opening the rings 13.

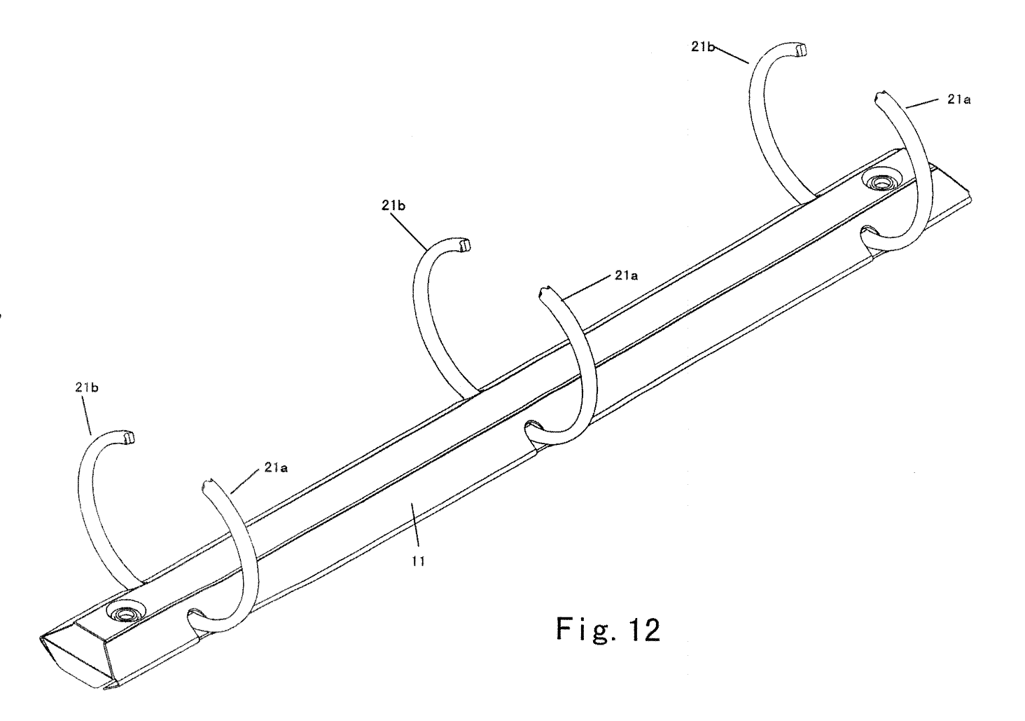

However, if the operator attempts to pull the particular ring 13 adjacent to the projection 33a apart as shown in FIGS. 9-11, the force to make the hinge plates 25a, 25b pivot upward causes the sloping portion 39′ of the projection 33a to slide along the sloping protrusion 27a′ on the hinge plates 25a, 25b so that the travel bar 31 moves toward the left side of the drawings relative to the housing 11 until the shoulder portions 37 of the projections 33b, 33c move out of the hinge plates 25a, 25b and into the positions corresponding to the openings formed by the cutouts 27b, 27c. When the hinge plates further pivot through the coplanar position, they deform the housing and cause a spring force that urges the hinge plates 25a, 25b to pivot upward away from the coplanar position. The travel bar 31 moves toward the left side of the drawings so that the sloping portions 39 of the projections 33b, 33c slide along the sloping protrusion 27b′, 27c′ on the hinge plates 25a, 25b until the ring members 21a, 21b separate fully from each other to open the rings 13, as shown in FIGS. 12-14.

To close and lock the ring members 21a, 21b, the operator may push manually the ring members 21a, 21b of any ring 13 to close them. At that time, the hinge palates 25a, 25b pivot downward and the travel bar 31 moves toward the right side of the drawings under the tension force of the spring 45 so that the sloping portions of the projections slide along the sloping protrusion on the hinge plates 25a, 25b to move the projections 33b, 33c out of the corresponding openings. When the hinge plates further pivot downward through the coplanar position, the shoulder portions 37 of the projections 33b, 33c engage with the upper surfaces of the hinge plates 25a, 25b and the sloping portion 39′ of the projection 33a abuts against the edges of the opening formed by the cutouts 27a on the respective hinge plates 25a, 25b, thereby causing the ring binder mechanism 1 in the closed and locked position.

Therefore, the ring binder mechanism according to the present invention may be opened by pulling only the ring members of the particular ring. Otherwise, it is impossible to open the ring binder mechanism according to the present invention. It should be understood that one of the projections 33b, 33c may have the same structure as the projection 33a. In this case, the ring binder mechanism according to the present invention may be opened by pulling the ring members of the ring adjacent to the projection 33a or other projection having the same structure.

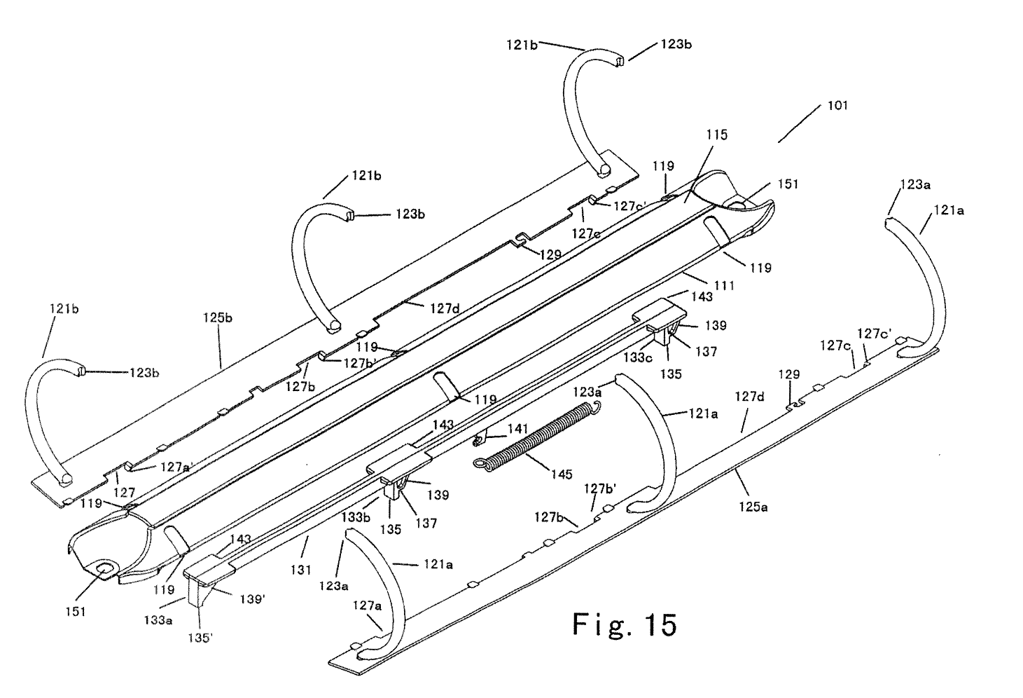

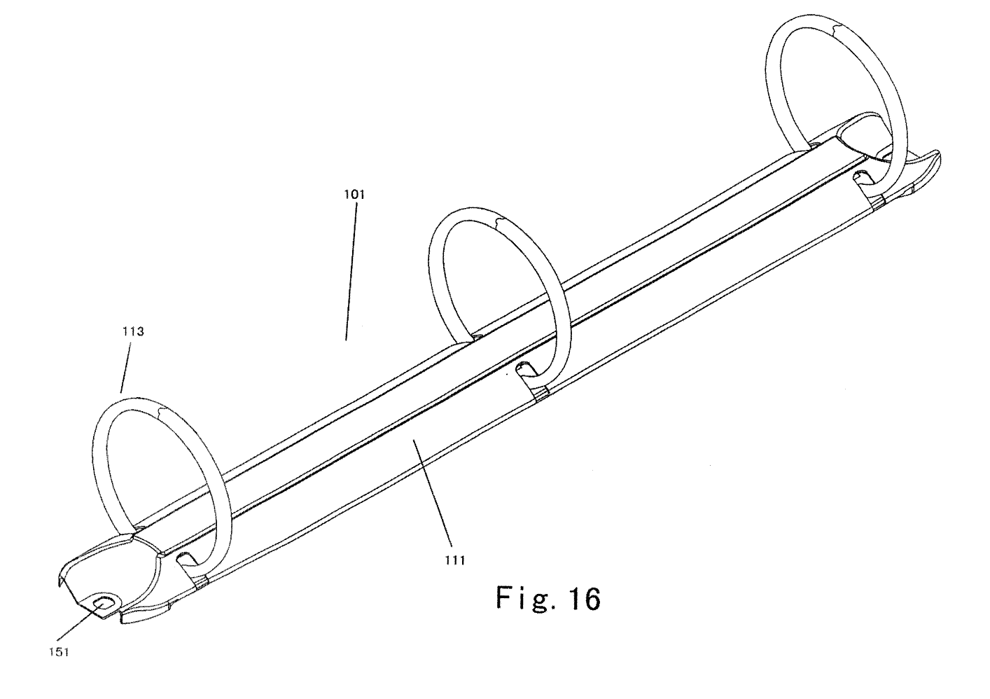

FIGS. 15 and 16 illustrate a second embodiment of the ring binder mechanism of the present invention. The mechanism of this embodiment is generally designated by reference numeral 101. Parts of the mechanism of this second embodiment corresponding to parts of the mechanism of the first embodiment are indicated by the same reference numerals, plus “100”. This embodiment is substantially similar to the first embodiment except that the structure of the ends of the housing 111 is different. In the second embodiment, a recess is formed at the two ends of the housing 111 respectively and a through hole 151 is formed in the bottom of the respective recess so that the ring binder mechanism may be attached to the cover of a file or a notebook.

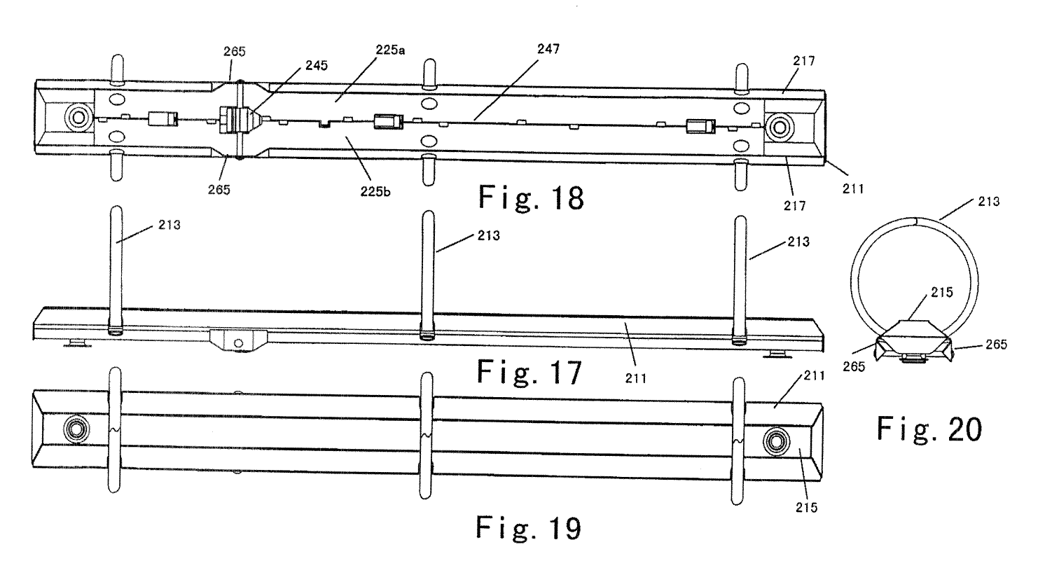

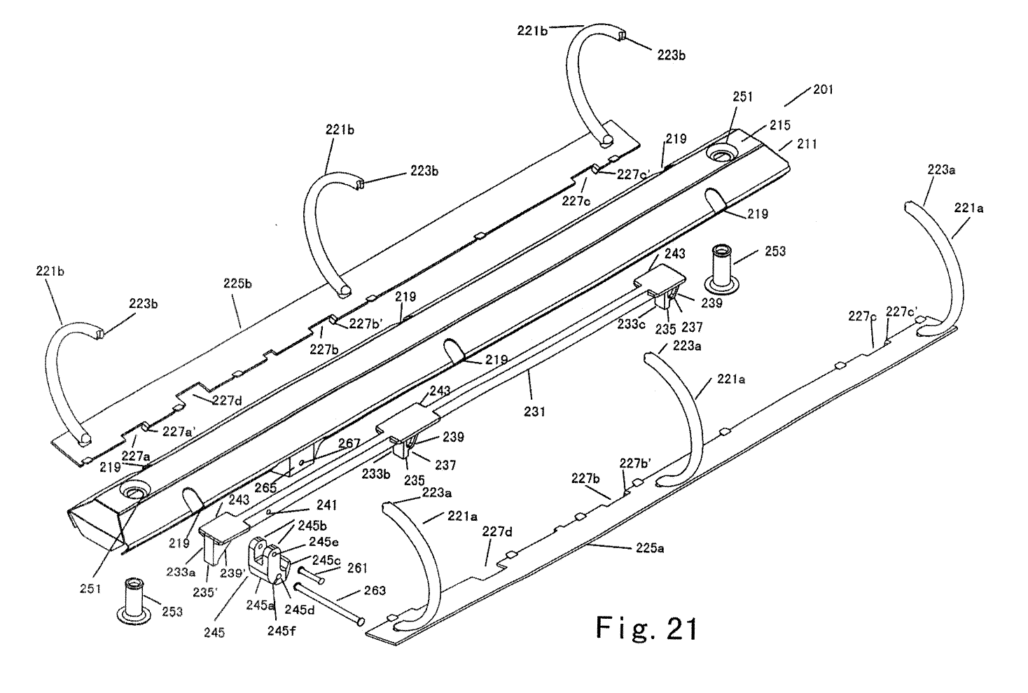

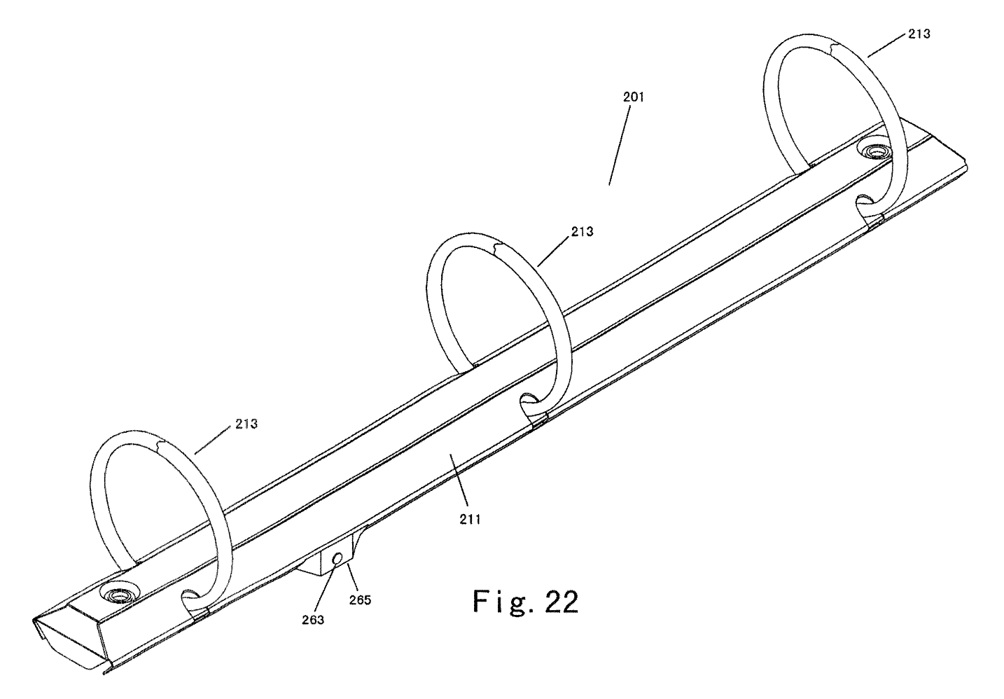

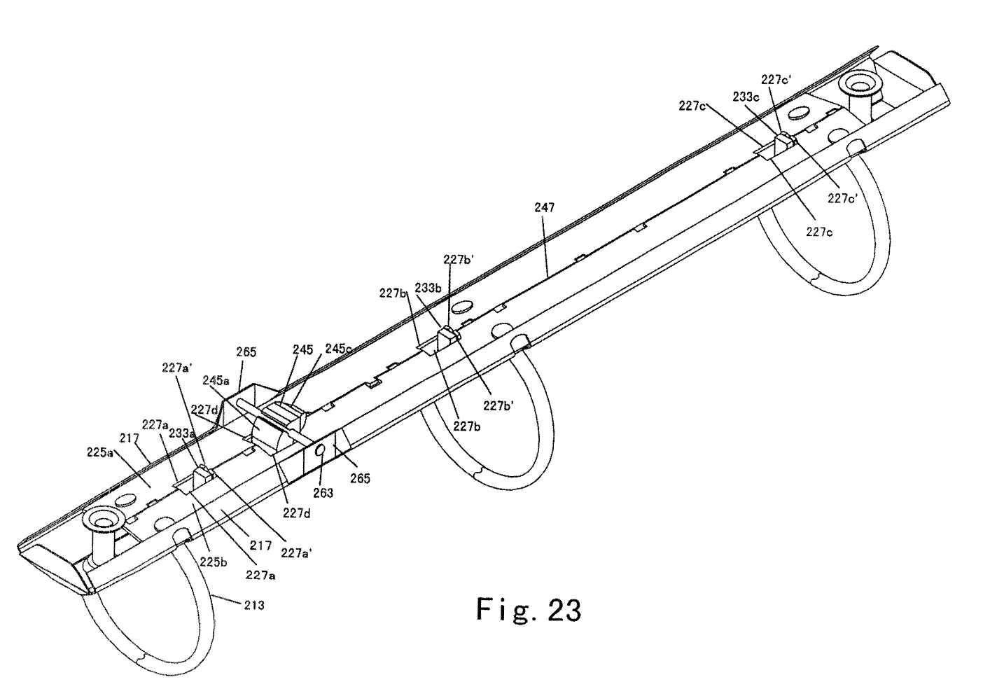

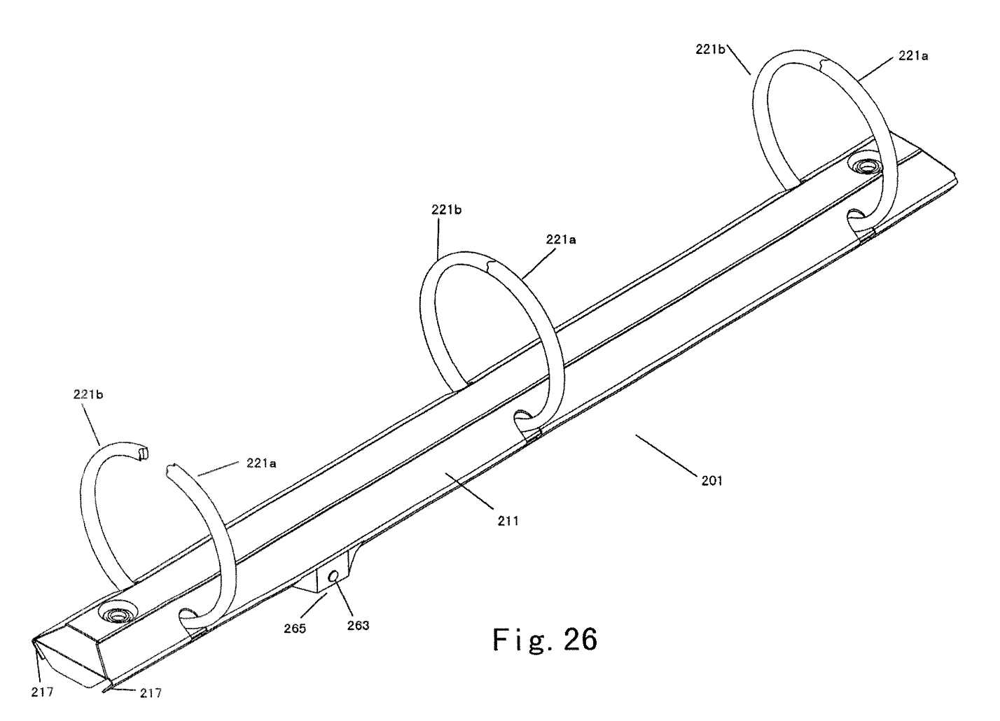

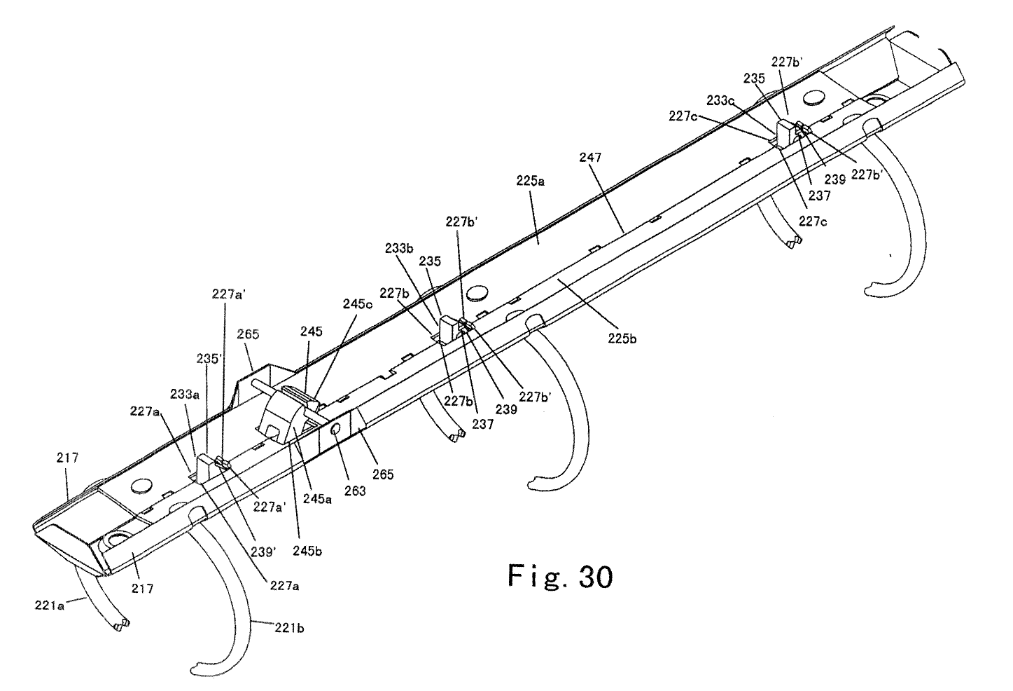

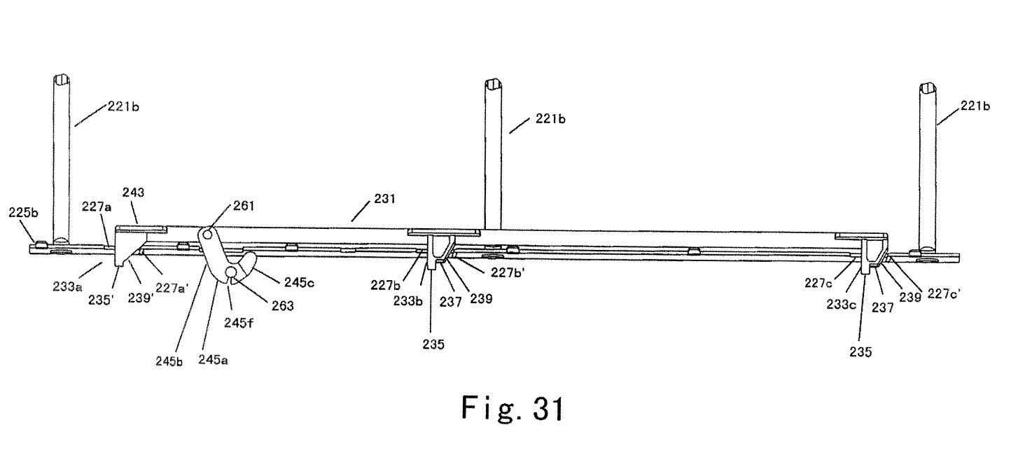

FIGS. 17-31 illustrate a third embodiment of the ring binder mechanism of the present invention. The mechanism of this embodiment is generally designated by reference numeral 201. Parts of the mechanism of this third embodiment corresponding to parts of the mechanism of the first embodiment are indicated by the same reference numerals, plus “200”. This embodiment is substantially similar to the first embodiment except that the spring 45 in the first embodiment is replaced by a rotatable member 245.

Specifically, in the ring binder mechanism 201 according to the third embodiment, since it is unnecessary to provide with the spring 45, neither the hooked portion 29 is formed on the hinge plates 225a, 225b nor the hooked portion 41 on the travel bar 231. The rotatable member 245 in the ring binder mechanism 201 according to the third embodiment is substantially J-shaped and includes a main body 245a, two arms 245b extending vertically upward from the main body 245a and spaced from each other and a hooked potion 245c extending from the lower end of the main body 245a. A through hole 245d is formed in the main body 245a and two additional through holes 245e are formed in the vertically extending arms 245b.

At a position corresponding to the cutouts 227d on the hinge plates, two extensions 265 extend respectively downward from the bent under rims 217 of the housing 211 adjacent to the ring 213 used to open the ring binder mechanism 201 so that the rotatable member 245 may be received within a space defined by the two opposite extensions 265. A through hole 267 is formed in the extension 265 respectively. Correspondingly, a through hole 241 is formed in the travel bar 231 adjacent to the projection 233a.

When assembled, the travel bar 231 is disposed in the space between two vertically extending arms 245b of the rotatable member 245 and connects with the rotatable member 245 via a hinge pin 261 extending through the through holes 245e, 241. Next, the travel bar 231 and the rotatable member 245 assembled together are disposed between the raised plateau 215 of the housing 211 and the hinge plates 225a, 225b so that the rotatable member 245 is received within the space defined by the two opposite extensions 265 on the bent under rims 217 of the housing 211 and connects with the housing 211 via a hinge pin 263 extending through the through holes 267 and 245d. The main body 245a and the hooked portion 245c of the rotatable member 245 extend through the opening formed by the cutouts 227d on the hinge plates to expose to the outside so that the free end of the hooked potion 245c abuts against the lower surface of the hinge plates 225a, 225b. Except for the difference mentioned above, the assembly of the ring binder mechanism 201 according to the third embodiment is substantially similar to that of the first embodiment.

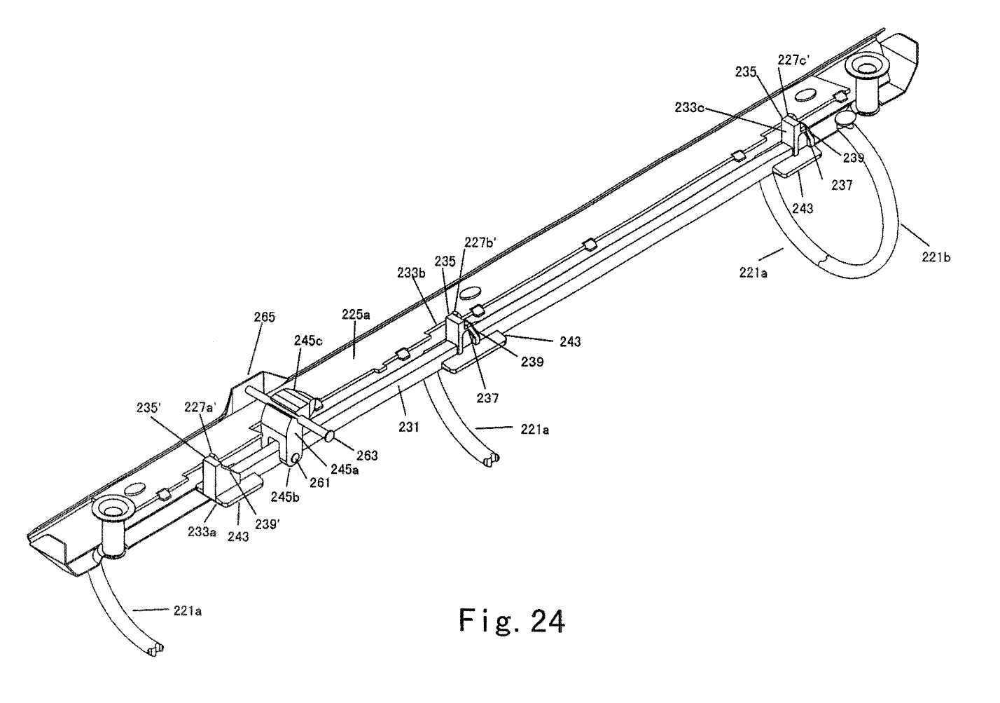

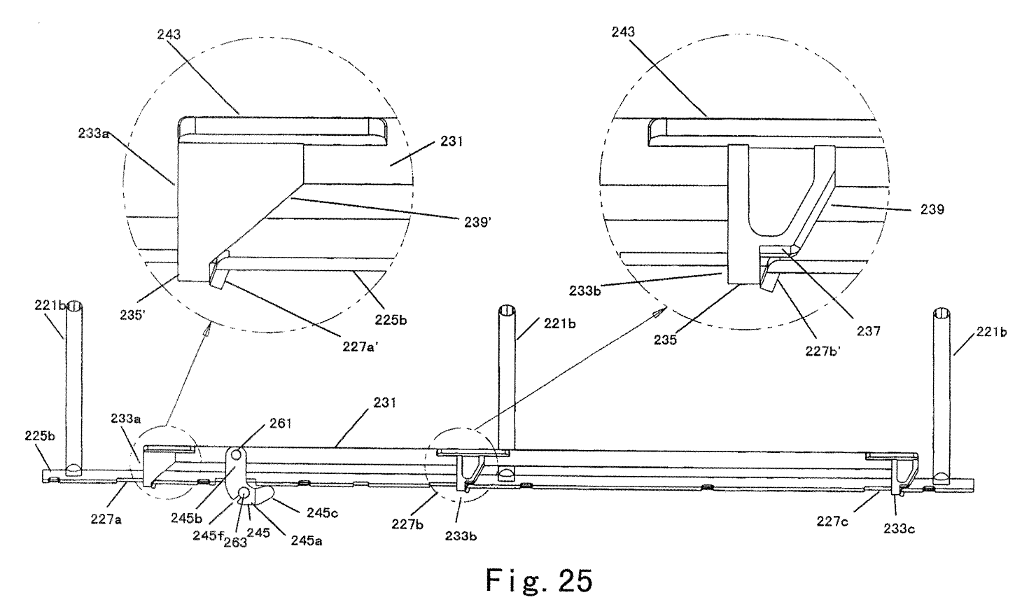

Referring to FIGS. 22-31, the operation of the ring binder mechanism 201 will be described. The ring binder mechanism 201 is shown to be in the closed and locked position in FIGS. 22-25. The hinge plates 225a, 225b are hinged downward away from the raised plateau of the housing 211 so that the ring members 221a, 221b of each ring 213 close together to form a continuous loop for retaining loose-leaf pages. As shown in FIGS. 24 and 25, the projections 233a-233c on the travel bar 231 align with the hinge 247 above the hinge plates 225a, 225b so that all of the suspending portions 235, 235′ of the projections 233a-233c are positioned in the openings formed by three cutouts 227a-227c on the respective hinge plates 225a, 225b while the shoulder portions 237 of the projections 233b, 233c engage with the upper surfaces of the hinge plates 225a, 225b and the sloping portion 239′ of the projection 233a abuts against the edges of the opening formed by the cutouts 227aon the respective hinge plates 225a, 225b. If an operator attempts to pull the rings 213 adjacent to the projections 233b, 233c apart, the projections 233b, 233c on the travel bar 231 between the hinge plates 225a, 225b and the raised plateau 215 of the housing block the hinge plates 225a, 225b from pivoting upward, thereby being incapable of opening the rings 213.

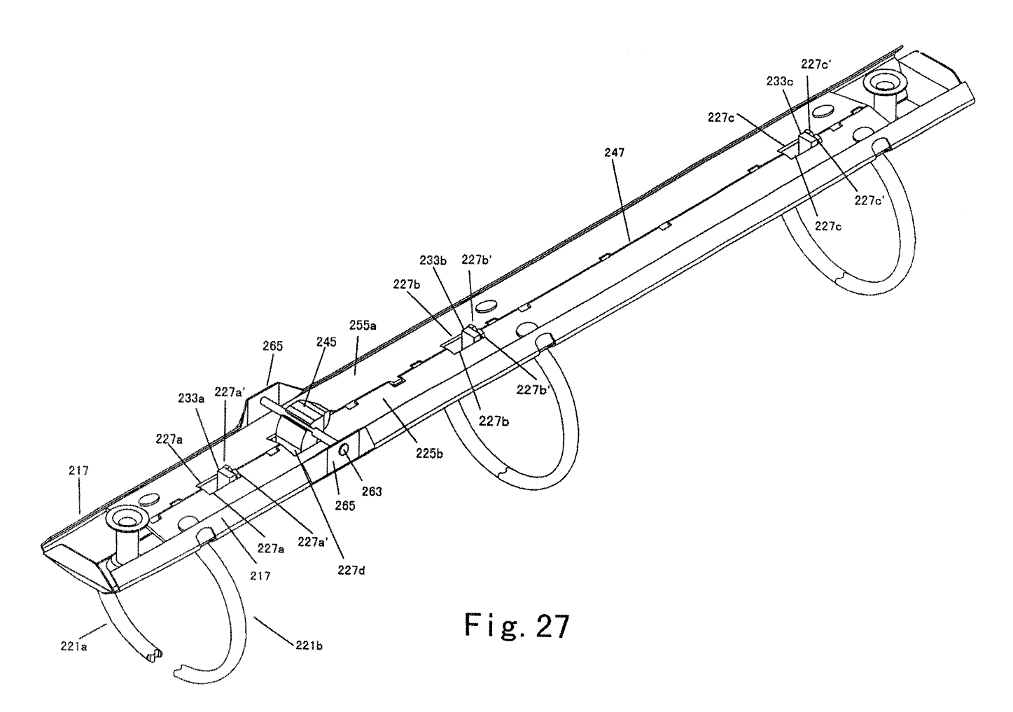

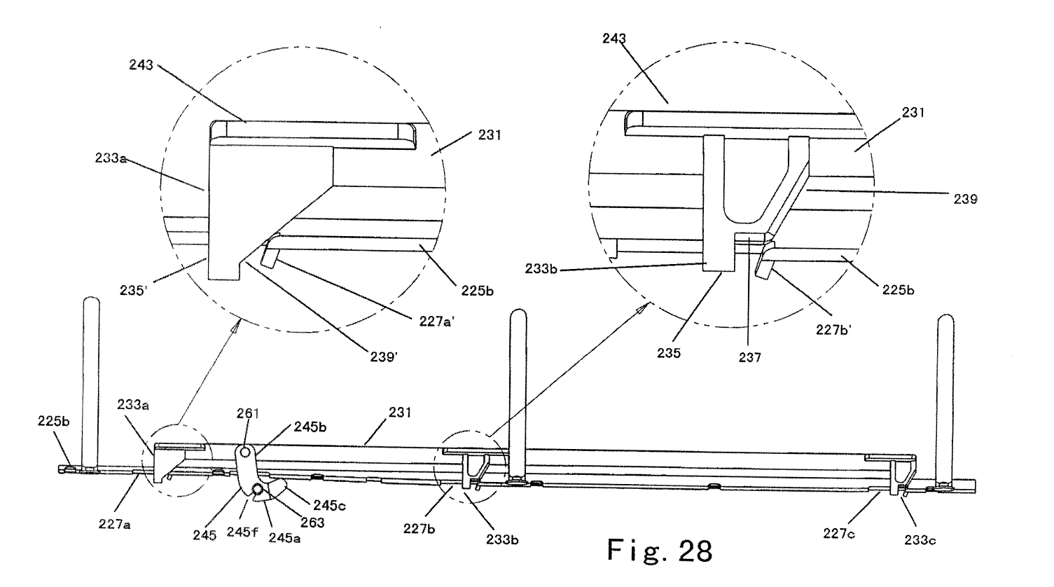

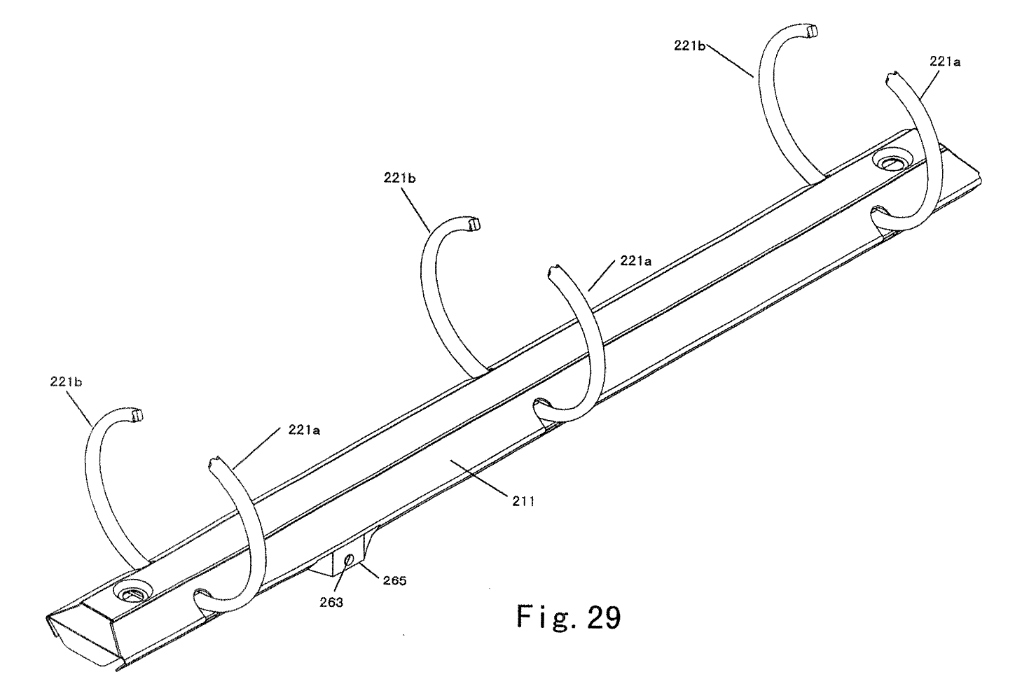

However, if the operator attempts to pull the particular ring 213 adjacent to the projection 233a apart as shown in FIGS. 27-28, the force to make the hinge plates 225a, 225b pivot upward causes the sloping portion 239′ of the projection 233a to slide along the sloping protrusion 227a′ on the hinge plates 225a, 225b so that the travel bar 231 moves toward the left side of the drawings relative to the housing 211. Moving the travel bar 231 toward the left side causes the rotatable member 245 to rotate anti-clockwise around the hinge pin 263 so that the free end of the hooked portion 245c of the rotatable member 245 further pushes the hinge plates 225a, 225b upward. The travel bar 231 further moves toward the left side relative to the housing 211 until the shoulder portions 237 of the projections 233b, 233c move out of the hinge plates 225a, 225b and into the positions corresponding to the openings formed by the cutouts 227b, 227c. When the hinge plates further pivot through the coplanar position, they deform the housing and cause a spring force that urges the hinge plates 225a, 225b to pivot upward away from the coplanar position. The travel bar 231 further moves toward the left side so that the sloping portions 239 of the projections 233b, 233c slide along the sloping protrusion 227b′, 227c′ on the hinge plates 225a, 225b until the ring members 221a, 221b separate fully from each other to open the rings 213, as shown in FIGS. 29-31.

To close and lock the ring members 221a, 221b, the operator may push manually the ring members 221a, 221b of any ring 213 to close them. At that time, the hinge palates 225a, 225b pivot downward and therefore push the free end of the hooked portion 245c of the rotatable member 245 downward so that the rotatable member 245 rotates clockwise around the hinge pin 263 to cause the travel bar 231 to move toward the right side of the drawings with the rotation of the rotatable member 245. As a result, the sloping portions of the projections slide along the sloping protrusion on the hinge plates 225a, 225b to move the projections 233b, 233c out of the corresponding openings. When the hinge plates 225a, 225b further pivot downward through the coplanar position, the shoulder portions 237 of the projections 233b, 233c engage with the upper surfaces of the hinge plates 225a, 225b and the sloping portion 239′ of the projection 233a abuts against the edges of the opening formed by the cutouts 227aon the respective hinge plates 225a, 225b , thereby causing the ring binder mechanism in the closed and locked position.

Therefore, the ring binder mechanism 201 according to the present invention may be opened by pulling only the ring members of the particular ring 213. Otherwise, it is impossible to open the ring binder mechanism according to the present invention. It should be understood that one of the projections 233b, 233c may have the same structure as the projection 233a. In this case, the ring binder mechanism according to the present invention may be opened by pulling the ring members of the ring adjacent to the projection 233a or other projection having the same structure.

To rotate smoothly the rotatable member 245 with the movement of the travel bar 231 or move smoothly the travel bar with the rotation of the rotatable member when the ring binder mechanism 201 is operated to open or close the ring members, a through slot 245f may be formed in the main body 245a of the rotatable member 245 so that the rotatable member 245 may be deformable to facilitate the rotation.

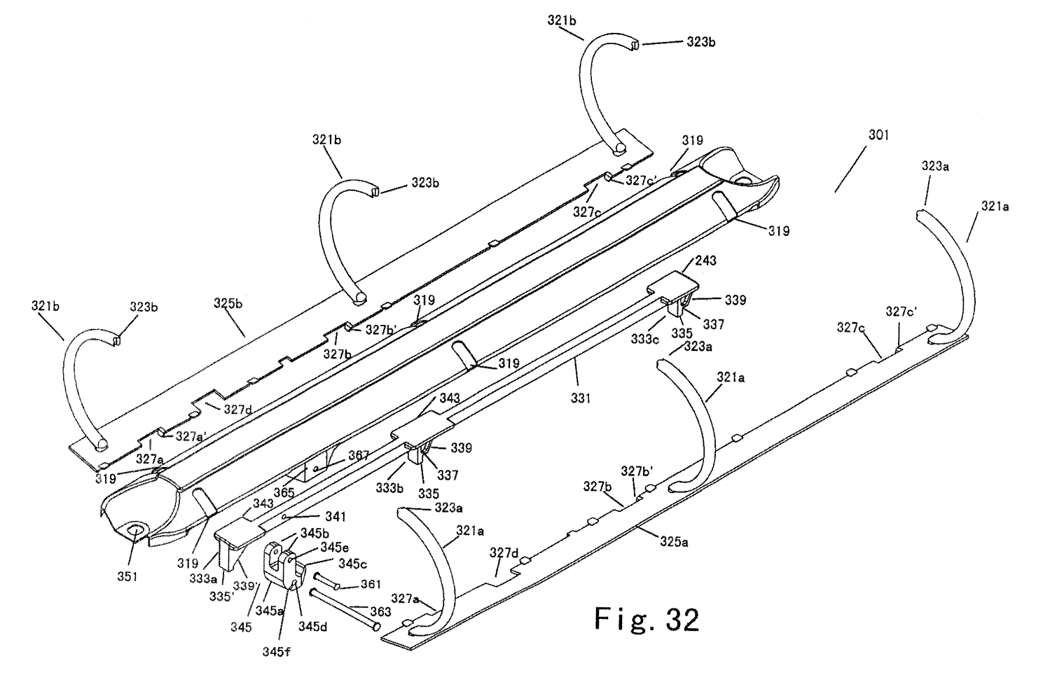

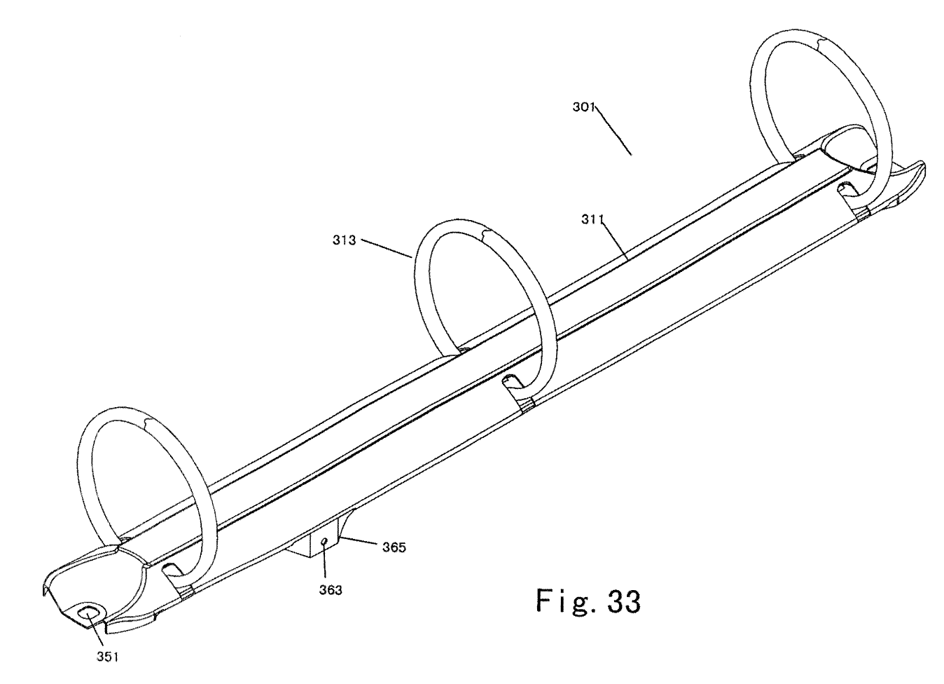

FIGS. 32 and 33 illustrate a fourth embodiment of the ring binder mechanism of the present invention. The mechanism of this embodiment is generally designated by reference numeral 301. Parts of the mechanism of this fourth embodiment corresponding to parts of the mechanism of the third embodiment are indicated by the same reference numerals, plus “100”. This embodiment is substantially similar to the first embodiment except that the structure of the ends of the housing 311 is different. In the fourth embodiment, a recess is formed at the two ends of the housing 311 respectively and a through hole 351 is formed in the bottom of the respective recess so that the ring binder mechanism may be attached to the cover of a file or a notebook.

Components of the mechanism of the present invention according to the several discussed embodiments are made of a suitable rigid material, such as metal (e.g., steel). But mechanisms made of a nonmetallic material, specifically including plastic, do not depart from the scope of this invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up”, “down”, “upward”, “downward”, “upper”, “lower”, “left”, “right” and variations thereof is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A ring binder mechanism for retaining loose-leaf pages, the mechanism comprising:
a housing having a top portion and an open bottom generally opposed to the top portion;
hinge plates supported by the housing for pivoting motion relative to the housing;
rings for holding loose-leaf pages, each ring including a first ring member and a second ring member, the first ring member being mounted on a first hinge plate and moveable with the pivoting motion of the first hinge plate relative to the second ring member between a closed position and an open position, in the closed position the two ring members forming a substantially continuous, closed loop for allowing loose-leaf pages retained by the rings to be moved along the rings from one ring member to the other, and in the open position the two ring members forming a discontinuous, open loop for adding or removing loose-leaf pages from the rings; and
a travel bar disposed between the top portion of the housing and the hinge plates and having a plurality of projections, at least one of the projections having a structure to block the hinge plates from pivoting upward relative to the housing and at least other one of the projections having a structure to allow the hinge plates to pivot upward relative to the housing.

2. A ring binder mechanism as set forth in claim 1 wherein the at least one of the projections having a structure to block the hinge plates from pivoting upward relative to the housing comprises a suspending portion extending downward from the bottom surface of the travel bar, a shoulder portion extending from the suspending portion and a sloping portion extending upward and slopingly from the shoulder portion toward the bottom surface of the travel bar, the shoulder portion blocking the hinge plates from pivoting upward relative to the housing when the shoulder portion engages with the upper surface of the hinge plates.

3. A ring binder mechanism as set forth in claim 1 wherein the at least other one of the projections having a structure to allow the hinge plates to pivot upward relative to the housing comprises a suspending portion extending downward from the bottom surface of the travel bar and a sloping portion extending upward and slopingly from the suspending portion toward the bottom surface of the travel bar, the sloping portion being slidable relative to the hinge plates for allowing the hinge plates to pivot upward relative to the housing.

4. A ring binder mechanism as set forth in claim 1 further comprising moving means connected with the travel bar for moving the travel bar.

5. A ring binder mechanism as set forth in claim 4 wherein the moving means comprises a spring connected between the travel bar and the hinge plates, the spring being in a tensioned state.

6. A ring binder mechanism as set forth in claim 4 wherein the moving means comprises a rotatable member attached to the travel bar.

7. A ring binder mechanism as set forth in claim 6 wherein the rotatable member is substantially J-shaped.

8. A ring binder mechanism as set forth in claim 6 wherein the rotatable member comprises a hooked portion of which the free end engages with the lower surface of the hinge plate, and the rotatable member is attached rotatably to the underside of the housing.

9. A ring binder mechanism as set forth in claim 6 wherein the rotatable member comprises a through slot formed in the main body so that the rotatable member is deformable to rotate easily.

10. A ring binder mechanism as set forth in claim 1 wherein the projections are formed integrally with the travel bar.

11. A ring binder mechanism as set forth in claim 1 wherein the projections project from the bottom surface of the travel bar in a substantially L-shape.

12. A ring binder mechanism as set forth in claim 1 wherein at least one of the hinge plates has openings, the suspending portions of the projections are positioned in the openings when the ring members are in closed state and the major portions of the projections are positioned in the openings when the ring members are in open state.

13. A ring binder mechanism as set forth in claim 1 further comprising at least one horizontal extension formed on the top surfaces of the travel bar, the horizontal extension is received within the housing to guide the travel bar to move along the longitudinal direction of the housing.

14. A ring binder mechanism as set forth in claim 1 wherein one of the projections has a structure to allow the hinge plates to pivot upward relative to the housing and other projections have a structure to block the hinge plates from pivoting upward relative to the housing.

15. A ring binder mechanism as set forth in claim 14 wherein the ring binder mechanism is opened by pulling apart the ring members of the ring corresponding to the projection having a structure to allow the hinge plates to pivot upward relative to the housing; the ring binder mechanism remains closed by pulling the ring members of the rings corresponding to the projections having a structure to block the hinge plates from pivoting upward relative to the housing.
